(19) United States
(12) Patent Application Publication
(10) Pub. No.: US 2013/0080464 A1
(43) Pub. Date: Mar. 28, 2013

(54) PROVIDING ENERGY PRODUCTION DATA

(71) Applicant: Christopher T. GEORGE, Houston, TX (US)

(72) Inventor: Christopher T. GEORGE, Houston, TX (US)

(21) Appl. No.: 13/627,167

(22) Filed: Sep. 26, 2012

Related U.S. Application Data
(60) Provisional application No. 61/539,295, filed on Sep. 26, 2011.

(51) Int. Cl. G06F 17/30

(52) U.S. Cl. 707/769; 707/E17.014

(57) ABSTRACT

In at least some disclosed embodiments, a non-transitory computer-readable storage medium includes executable instructions that, when executed, cause one or more processors to receive, from a remote device, a query comprising parameters for energy production data. The one or more processors are further caused to search a database of energy production data, comprising oil production data or natural gas production data, for energy production data falling within the parameters of the query (“resultant data”). The one or more processors are further caused to send, to the remote device in response to the query, the resultant data in a form specified by the parameters of the query.

### CROSS-REFERENCE TO RELATED APPLICATIONS

The present application claims priority to provision application 61/539,295 filed on Sep. 26, 2011 and entitled “Oil and Gas Rig Data Application,” which is herein incorporated by reference.

### BACKGROUND

Not only is data difficult to obtain, but it is difficult to process into visualizations to create interpretations, conclusions, and predictions. Such difficulty impedes our natural desire to consider data through various lenses to rigorously test interpretations, conclusions, and predictions for robustness. Such difficulty also impedes our ability to creatively “play” or brainstorm with data in order to reach unintuitive interpretations, conclusions, and predictions.

### SUMMARY

Mediums, systems, and methods for providing energy production data are described herein. In at least some disclosed embodiments, a non-transitory computer-readable storage medium includes executable instructions that, when executed, cause one or more processors to receive, from a remote device, a query comprising parameters for energy production data. The one or more processors are further caused to search a database of energy production data, comprising oil production data or natural gas production data, for energy production data falling within the parameters of the query (“resultant data”). The one or more processors are further caused to send, to the remote device in response to the query, the resultant data in a form specified by the parameters of the query.

In at least some disclosed embodiments, a system includes one or more processors and memory coupled to the one or more processors. The memory comprises executable instructions that, when executed, cause the one or more processors to receive, from a remote device, a query comprising parameters for energy production data. The one or more processors are further caused to search a database of energy production data, comprising oil production data or natural gas production data, for energy production data falling within the parameters of the query (“resultant data”). The one or more processors are further caused to send, to the remote device in response to the query, the resultant data in a form specified by the parameters of the query.

In at least some disclosed embodiments, a method includes receiving, using one or more processors, from a remote device, a query comprising parameters for energy production data. The method further includes searching, using the one or more processors, a database of energy production data, comprising oil production data or natural gas production data, for energy production data falling within the parameters of the query (“resultant data”). The method further includes sending, using the one or more processors, to the remote device in response to the query, the resultant data in a form specified by the parameters of the query.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates a system of providing energy production data in accordance with at least some illustrated embodiments;

FIG. 2 illustrates a system of providing energy production data in accordance with at least some illustrated embodiments;

FIG. 3 illustrates data flow within a system of providing energy production data in accordance with at least some illustrated embodiments;

FIG. 4 illustrates a particular machine for providing energy production data in accordance with at least some illustrated embodiments;

FIG. 5 illustrates a remote device for providing for providing energy production data in accordance with at least some illustrated embodiments;

FIGS. 6A-6D illustrate inputs and outputs for providing energy production data in accordance with at least some illustrated embodiments;

FIG. 7 illustrates outputs for providing energy production data in accordance with at least some illustrated embodiments; and

FIGS. 8A-8M illustrate inputs and outputs for providing energy production data in accordance with at least some illustrated embodiments.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, wireless connection, etc. Additionally, the term “system” refers to a collection of two or more hardware components, and may be used to refer to an electronic device or a subsystem of an electronic device.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims, unless otherwise specified. In addition, the following description has broad application. The discussion of any embodiment is meant only to be exemplary of that embodiment and not intended to intimate that the scope of the disclosure, including the claims, is limited to that embodiment.

In at least one embodiment, a remote device (e.g., a computer, mobile device, smartphone, tablet, workstation, laptop, and the like) may query for energy production data (e.g., oil or natural gas production data and the like) using one or more various parameters or filters such as region, target, drilling direction, rig type, operator, and service provider. The remote device may communicate the query to a server (e.g., an application server, a database server, a blade server, a data repository, and the like) though a wired or wireless connection with other devices in between the remote device and the server to facilitate communication (e.g., routers, satellites, cellular towers, internet servers, and the like). A region may be a country, state, county, play, or other granularity of geographic area. A drilling direction may be horizontal, vertical, directional, or a specified angle of drilling. A rig type may be a platform, drill ship, semi-submersible, jackup rig, land rig, float rig, or other type of rig. An operator and service provider may be a name value, e.g., the name of a company.

The response to the query may be graphs, exports, and reports in various embodiments or raw data for the remote device to construct graphs, exports, and reports in various embodiments. For example, a graph may visually depict the data returned (“resultant data”) from the user's query (e.g. a linear or stacked area graph). A user may select an array of various additional graphs they would like to view on the remote device. For example, the user may select bar, line, area, or pie graph, and the user may also specify the units or granularity of the axes of the graph. When viewing the graph, the user may manipulate or select various elements of the graph. For example the user may show and hide the legend of the graph or rotate and resize the graph using gestures such as pinch-zoom, spread-expand, and the like or pointers or pointing devices such as a computer mouse, trackball, and the like. If the graph is constructed on the server, altering the graph may result in another query if more data is needed. The second query behaves similarly to the first in various embodiments, and data already retrieved and usable for the second query is not retrieved again in various embodiments. Rather, only new data is retrieved.

An export may be a spreadsheet of rows and columns of energy production data. The export may have different levels of granularity, for example, aggregate, by state, by county, by play, by operator, or by contractor/driller. An aggregate data export may show the split between target (e.g. oil, gas, and other), drilling direction (e.g. vertical, horizontal, and directional), or a combination thereof (e.g. horizontal gas) as queried. The county export may reveal the activity level by county for the geographic region selected. The operator export may reveal the queried operator's activity by county and state. The reporting function may summarize oil and gas activity using the various parameters such as country, state, county, play, operator, and contractor/driller.

A report may be a selection of ranked data according to a threshold. For example, the report may rank the top threshold, e.g. top 15, by activity level in all the aforementioned categories by the queried level of granularity. Other thresholds may be used in various embodiments. Similarly, a bottom threshold may also be constructed. In at least one embodiment, a user may be guided through a series of inputs using a graphical user interface on the remote device. The guide may comprise a series of questions regarding parameters and thresholds in various embodiments. The inputs, or answers to the questions, inform the remote device how to construct the query. Advanced users may construct or generate the query directly.

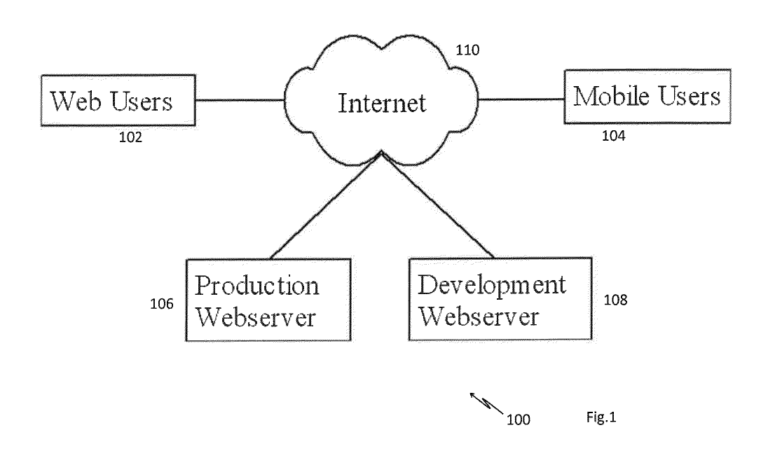

FIG. 1 illustrates a system 100 of providing energy production data. The energy production data may be oil or gas production data. Web users 102 and mobile users 104 may connect to production server 106 and development server 108 via network 110 and remote devices. The network 110 may be the Internet, web users 102 may use a desktop computer interface, laptop computer interface, and the like, and mobile users 104 may use a smartphone interface, PDA interface, phone interface, SMS interface, tablet interface, and the like. In various embodiments the interfaces may be a browser, operating system, or other application loaded onto the platform to present a graphical user interface to the user. The user may use inputs such as a pointing device, computer mouse, keyboard, touchscreen, and the like to interact with the graphical user interface. The servers 106, 108 may be webservers, blade servers, rack servers, and the like, and they may reside geographically near or far from the user in various embodiments. Communication in the system 100 may be implemented in the form of sending and receiving messages or packets. The messages may take many forms and include many components such as queries, response to queries, acknowledgements, packet headers, data payloads, and the like.

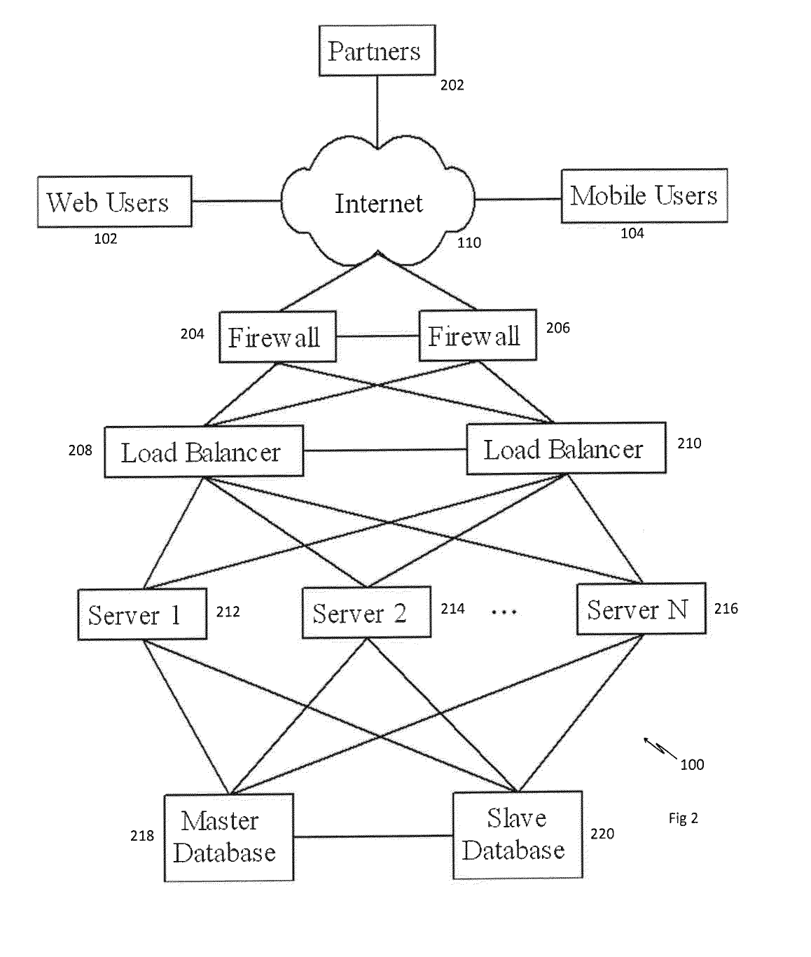

FIG. 2 illustrates another embodiment of system 100. Partners 202 may communicate on the network 110 to the other various entities via another network interface. Such communication may be public or private and may be directed to a particular entity in various embodiments. Such communication may occur within the interface provided for providing energy production data, encrypted or unencrypted in various embodiments, rather than outside sources such as email. Partners 202 may send and receive administrative messages, regulatory messages, support messages, and the like in various embodiments. The servers 212, 214, 216 may be protected by firewalls 204, 206, and may distribute processes between them using load balancers 208, 210 according to the servers' capacity, use, wear, latency, and the like. Firewalls 204, 206 may prevent unauthorized access to the servers 212, 214, 216 and databases, 218, 220 as well as provide protection from unauthorized scripts and viruses. The system 100 may implement one or more types of authentication using passwords, biometrics, authentication tokens, and the like.

The servers 212, 214, 216 may perform the bulk of the processing, such as construction of graphs, reports, and exports, but use databases 218, 220 for storage of information such as raw data. The servers 212, 214, 216 may retrieve raw data from the databases 218, 220 and manipulate the raw data based on received queries. The databases 218, 220 may be configured in a master/slave relationship and may comprise multiple types and quantities of storage elements. Each element of the system 100 may have a designated backup to which it fails over in case of error. Such backups may also be configured in a master/slave relationship with their corresponding entities.

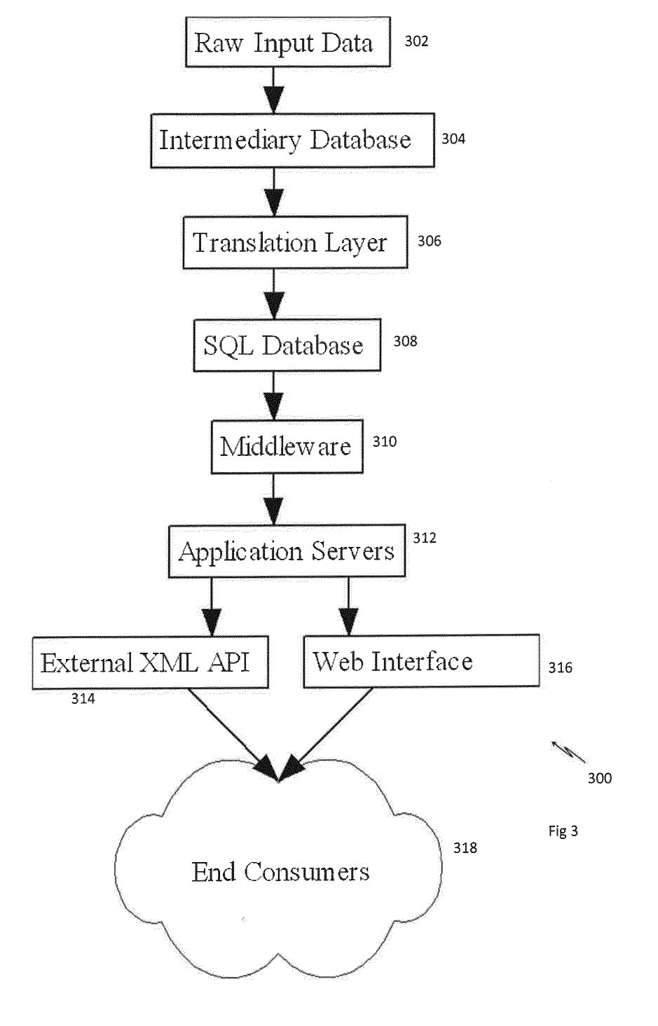

FIG. 3 illustrates a logical flow 300 of data throughout the system 100 in accordance with at least some embodiments. The raw input data 302 may be energy production data such as oil and gas production data. The data may be collected from one or more sources by a data aggregator in at least one embodiment. In at least one embodiment the data aggregator may automatically, i.e. without human intervention, scrape websites, free or subscription based, of energy production firms for the latest data In other embodiments, the data may be collected manually and fed to the data aggregator. The raw data may be organized, automatically or manually in various embodiments, into database format into an intermediary database 304. This intermediate database 304 may be standardized, universal, or otherwise unoptimized for a particular brand of database software. Translation layer 306 may translate and optimize the intermediary database 304 into SQL, or structured query language, database 308 format. In various embodiments, the translation layer 306 may translate and optimize the intermediary database 304 for other brands of database software. Middleware 310 may translate communication between the SQL database 308 and application servers 312. End consumers 318 may use interfaces such as web interface 316 or external XML API interface 314 to access the application servers 312 to ultimately query and receive the energy production data according to various parameters and in a requested form. Responses may use XML (extensible markup language) format or JSON (JavaScript object notification) format.

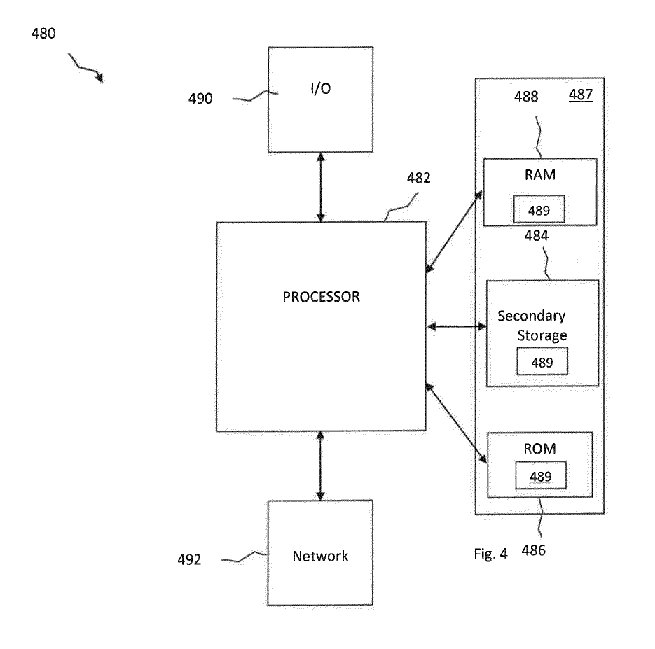

A server 212, 214, 216 may be implemented on a particular machine with sufficient processing power, memory resources, and network throughput capability to handle the necessary workload placed upon it. FIG. 4 illustrates a particular machine 480 suitable for implementing one or more embodiments disclosed herein. The particular machine 480 may include a processor 482 (which may be referred to as a central processor unit or CPU) that is in communication with a non-transitory computer-readable medium or non-transitory machine-readable medium 487. The medium 487 may store software that, when executed by one or more processors 482, causes the one or more processors 482 to perform or initiate any of the steps described in this disclosure. The machine-readable medium 487 may comprise memory devices including secondary storage 484, read only memory (ROM) 486, and random access memory (RAM) 488. The processor 482 may be in further communication with input/output (I/O) 490 devices and network connectivity devices 492. The processor 482 may be implemented as one or more CPU chips.

The secondary storage 484 may comprise one or more disk drives and may be used for non-volatile storage of data and as an over-flow data storage device if RAM 488 is not large enough to hold all working data. Secondary storage 484 may be used to store programs which are loaded into RAM 488 when such programs are selected for execution and may cause the processor 482 to perform any of the steps described in this disclosure. The ROM 486 may be used to store instructions 489 and, in some embodiments, data which are read during program execution. ROM 486 may be a non-volatile memory device which typically has a small memory capacity relative to the larger memory capacity of secondary storage. The RAM 488 may be used to store volatile data and, in some embodiments, to store instructions 489. Access to both ROM 486 and RAM 488 may be faster than to secondary storage 484.

I/O 490 devices may include printers, video monitors, liquid crystal displays (LCDs), touch screen displays, keyboards, keypads, switches, dials, mice, track balls, voice recognizers, card readers, paper tape readers, or other input devices. The network connectivity devices 492 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other network devices. These network connectivity 492 devices may enable the processor 482 to communicate with an Internet or one or more intranets. With such a network connection, the processor 482 may receive information from the network, or may output information to the network in the course of performing the actions described herein. Such information, which is often represented as a sequence of instructions 489 to be executed using processor 482, may be received from and output to the network.

The processor 482 may execute instructions 489, codes, computer programs, and scripts that it accesses from hard disk, floppy disk, optical disc (these various disk based systems may all be considered secondary storage 484), ROM 486, RAM 488, or the network connectivity devices 492. Special purpose logic, e.g., an FPGA (field programmable gate array) or an ASIC (application-specific integrated circuit) may provide energy production data as well. Logic relates to structure for performing one or more logical operations. For example, logic may comprise circuit elements which provide one or more output signals based upon one or more input signals. Such circuitry may comprise a finite state machine which receives a digital input and provides a digital output, or circuitry which provides one or more analog output signals in response to one or more analog input signals.

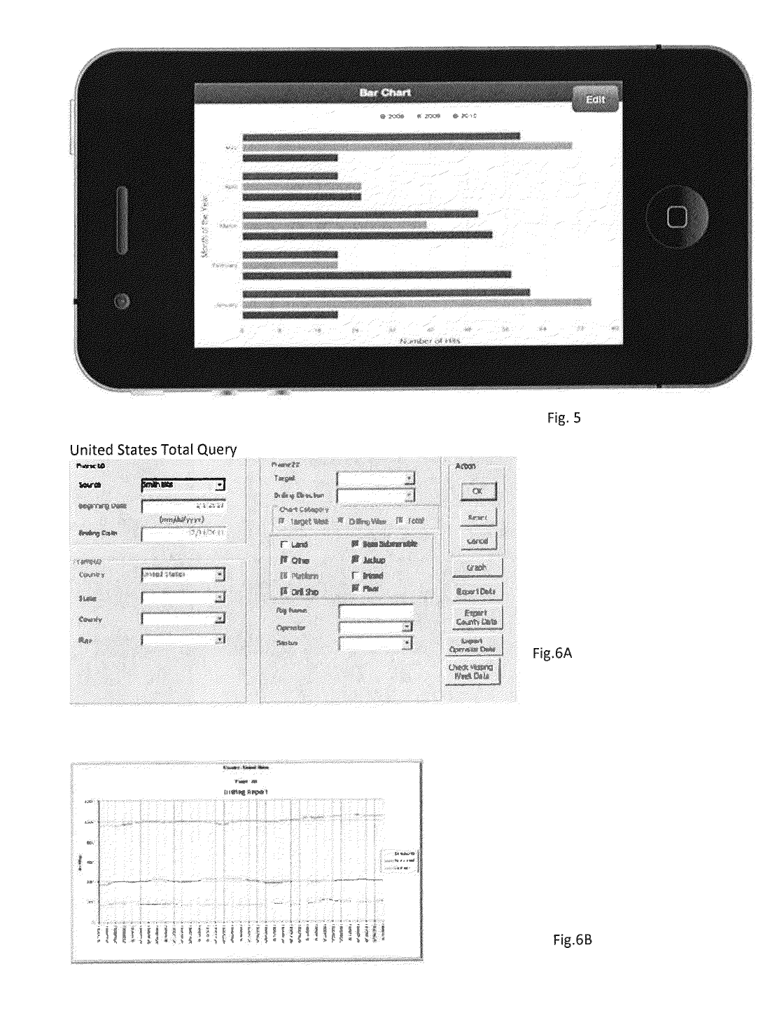

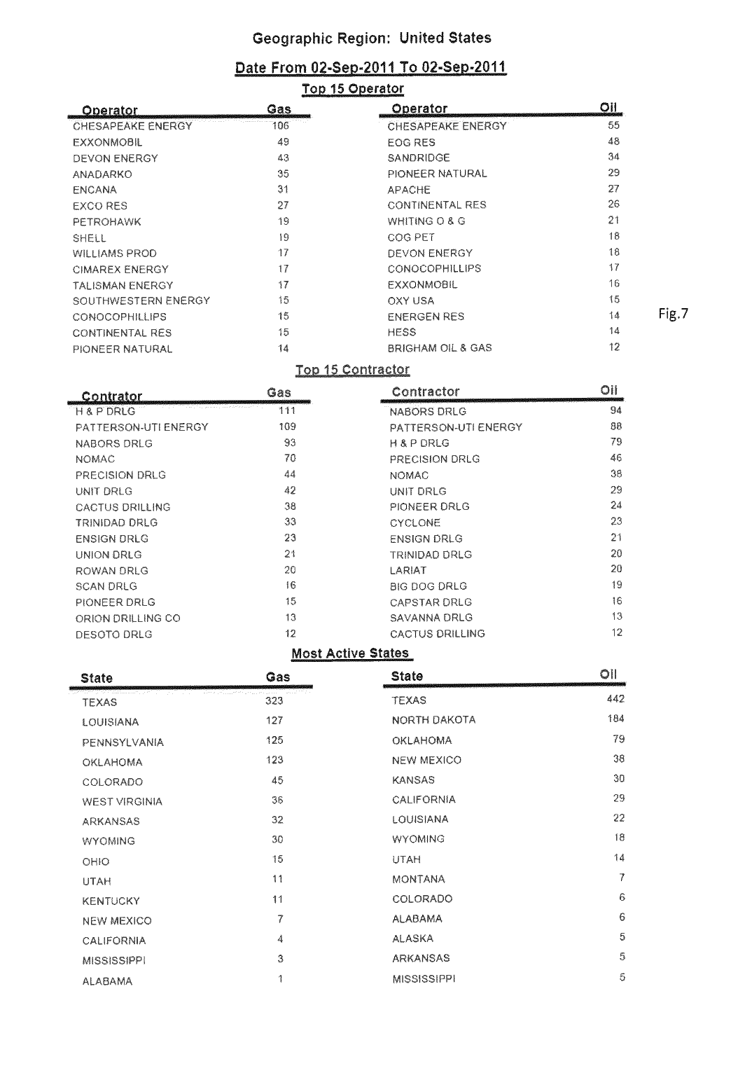

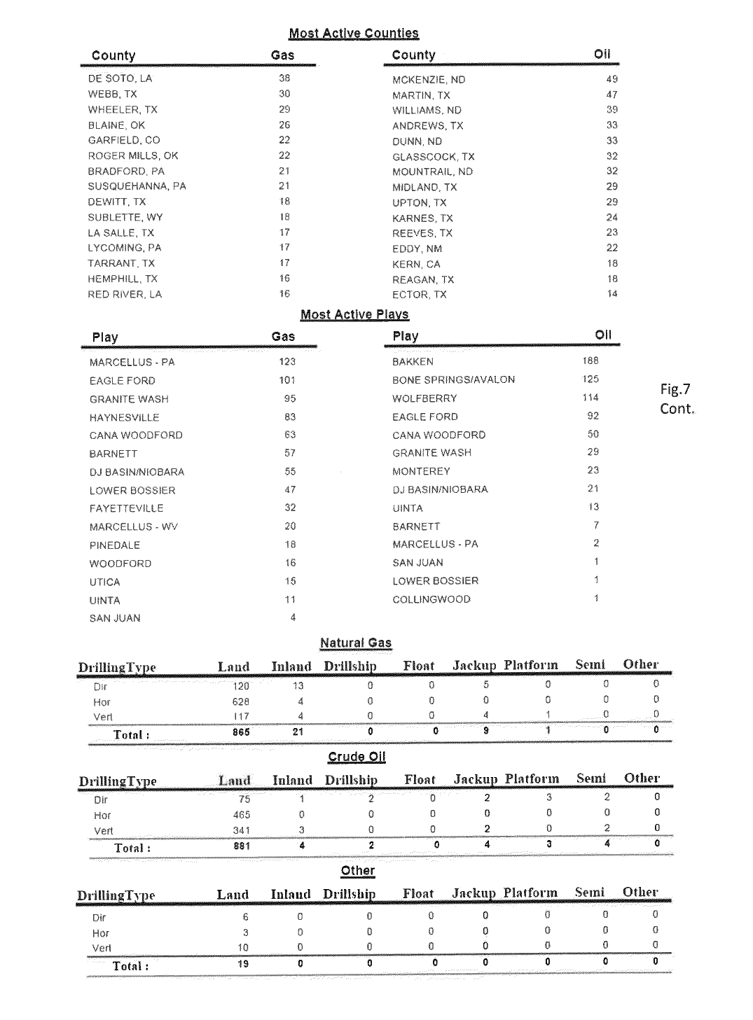

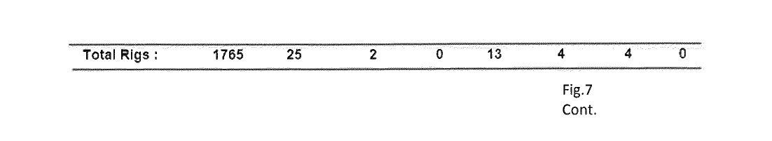

FIG. 5 illustrates a remote device showing a graph generated by a custom query specifying parameters. As illustrated, the remote device is a smartphone. However, the remote device may be other types of devices in various embodiments as described above. The remote device may comprise an antenna or transceiver for wireless communication, a processor, and memory coupled to the processor. The remote device may store an application that performs any step or action described herein. The application may display graphs, exports, and reports sent by a server, or the application may construct and format the graphs, exports, and reports locally based on energy production data received by the server in various embodiments. The graphs, exports, and reports may be explored, manipulated, and copied from using the interface features of the remote device. For example, the graphs may be zoomed into, zoomed out of, copied and pasted, edited by color or number, etc. using a touchscreen or pointing device. Selecting a portion of the graph, export, or report may lead to more detailed graphs, exports, or reports based on the selected portion. For example, if a user is viewing a report listing the top 15 operators in the country, the user may select one of the 15 operators by clicking on the operator name. Selecting the operator may cause the application to switch to a display listing all the rigs working for the chosen operator during the scope of the query (see FIG. 7D). Furthermore, selection of a region (e.g. state, county, play, or contract/driller) may lead to a detailed graph about the selected rigs. If not preloaded, such selection may cause a query to be sent to the server 212, 214, 216 requesting information about the selected operator. Further selection of a county may lead to a detailed graph about the selected operator's rigs in that county. If not preloaded, such selection may cause another query to be sent to the server requesting information about the selected county.

Many such permutations are possible, and in at least one embodiment, most if not all parameters displayed on a graph, export, or report may be selected for further detail about the selected parameter. In at least one embodiment, the choice of effect of selection of a parameter on a graph, export, or report is customizable. For example, in response to a selection of a county, a user may be able to change the default effect of seeing a detailed graph about a previously selected operator's rigs in that county to an effect of seeing a map of the selected county. In this way, every parameter has a default option when selected and is also individually customizable according to user preference in at least one embodiment.

The application may issue an alert through the remote device whenever particular rigging data meets or exceeds a specified customizable threshold. The alert may comprise a unique audio or visual message indicating the nature of the threshold breached. Also the alert may comprise multiple methods of communication in addition to the in-application message, such as short messaging service (“SMS”), email, phone call, social media messages (e.g. FACEBOOK or TWITTER message), and the like. As such, the remote device may be constantly or periodically updated with the latest energy production data according to user preferences. The application may also present a preview of a graph, export, or report before showing a full version. The preview may be a thumbnail or smaller version of the graph, export, or report. The preview may be an incomplete version of the graph, export, or report that populates as more energy production data is delivered to the mobile device in at least one embodiment. The application may accept touch, gesture, and tilt functionality as user interface inputs, and may provide different tiers of service for different levels of subscription to the application. The application may preload energy production data by storing energy production data when connected to the server 212, 214, 216 for use during an offline period of disconnection with the server. The application may store user preferences for particular views, parameters, alerts, links, icons, tones, shortcuts, and the like, and the application may store user profiles for storage of multiple sets of user preferences. Alerts and messages may originate from the application or may originate from the server to be pushed to the client application from the server.

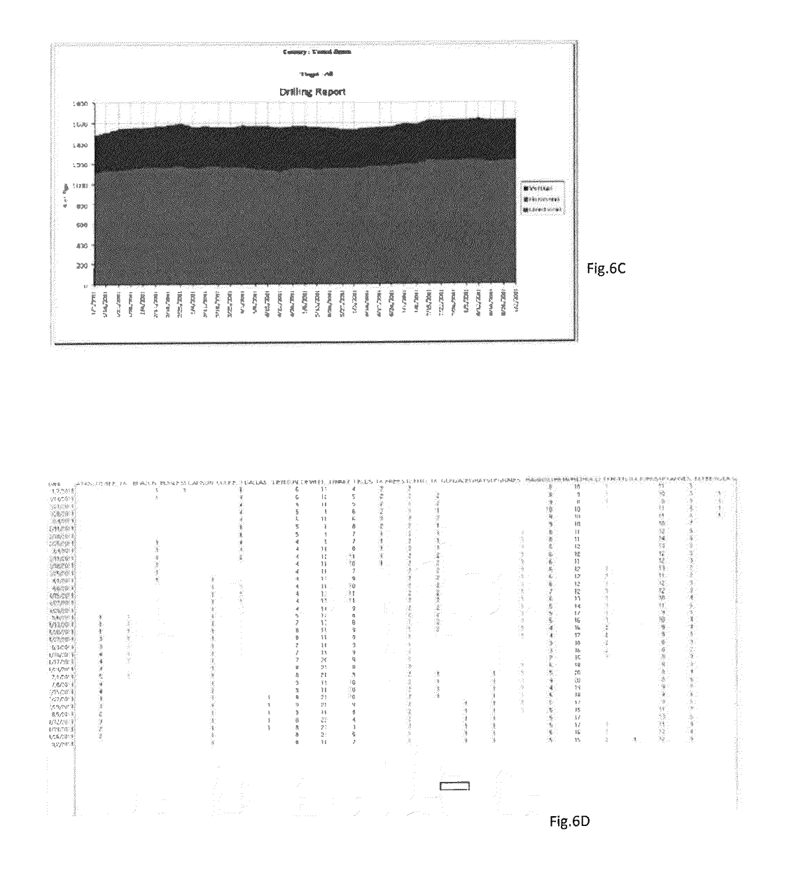

FIG. 6A illustrates a graphical user interface for constructing a query according to at least one embodiment. Parameters of the query that may be specified are source of the raw data, beginning date of desired period, ending date of desired period, country, state, county, play, target, drilling direction, graph category, target wise, drilling wise, total, land, other, platform, drill ship, semi-submersible, jackup, land rig, float, rig name, operator, status, graph, export data, export country data, export operator data, and check missing week data. Other parameters of energy production may be included as desired. The user may input specific thresholds or values for the parameters in order to return relevant results. FIG. 6B depicts a linear drilling wise, or drilling direction, graph that may be created in response to an appropriate query. In various embodiments, the graph itself may be sent to the user device or the rigging data may be sent with which the user device can construct the graph. Similarly, FIG. 6C illustrates a stacked area drilling wise graph. Many graphs of many parameters or combination of parameters may also be created. For example, the export parameter for U.S. rig activity split by direction (date, directional, horizontal, and vertical) may be created, a linear target wise graph may be created, and a stacked area target wise graph may be created. Also, exports may be created. These are only a few examples of graphs that can be created through queries. Many graphs of many parameters or combination of parameters may also be created,

FIG. 6D illustrates an export of a particular state's (Texas) horizontal gas data by county (Carson, Cooke, Dallas, etc.). Many exports of many parameters or combination of parameters may be created. For example, an export of total U.S. activity split by target (gas, oil, other) may be created, an export of Texas horizontal gas by operator (Anadarko, Apache, etc.) may be created, an export of Wheeler County by operator may be created, an export of the Barnett shale by drilling direction may be created, an export of the Barnett shale by county may be created, an export of the Barnett shale by operator may be created, and an export of the Chesapeake operator by county may be created. These are only a few examples of exports that can be created through queries. Many exports of many parameters or combination of parameters may also be created.

Similarly, reports can be generated. FIG. 7 illustrates a report generated via specification of various parameters. For example, some parameters are Country, State, County, Play, and Operator. The threshold specified is 15, and the threshold may vary in various embodiments. Each report may be organized differently, for example by Operator, Contractor/Driller, Most Active States, Most Active Counties, Most Active Plays, Drilling Direction by Target, and Rig Type. As can be seen, for a specific period of time (the day of Sep. 2, 2011) the top 15 operators, contractors, active states, active counties, and active plays are displayed separately for oil and gas. Also, for gas, oil, and other types of energy, the drilling type and direction are displayed as well as the total rig count. This is only one example of a report that can be created through a query. Many reports of many parameters or combination of parameters may also be created.

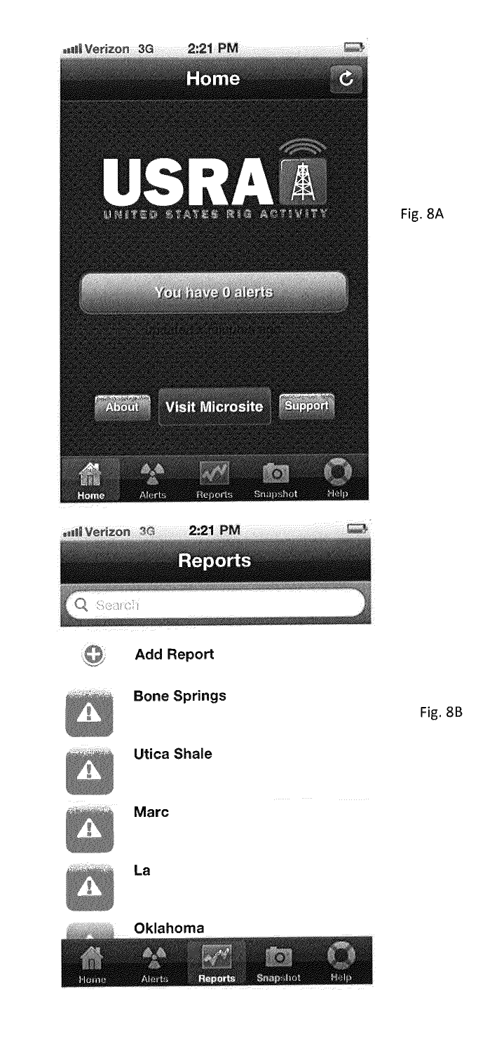

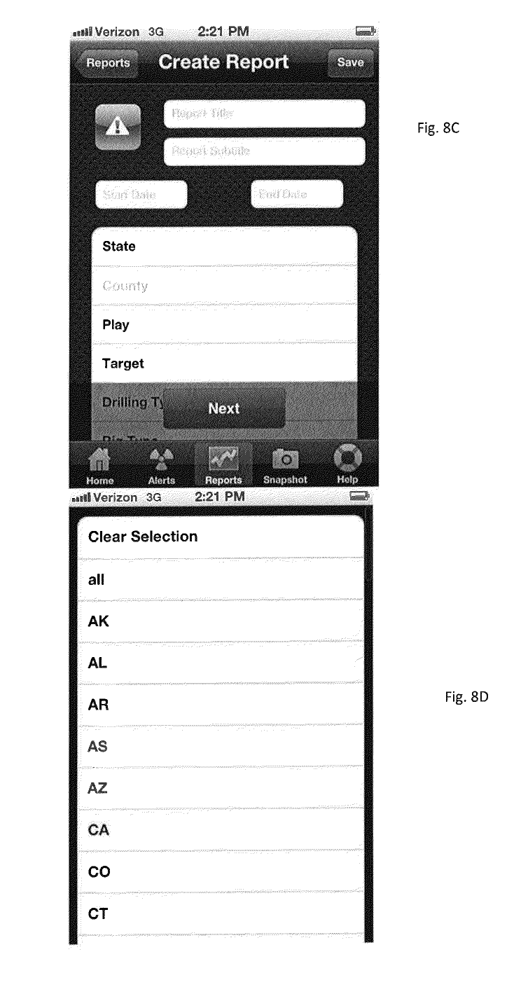

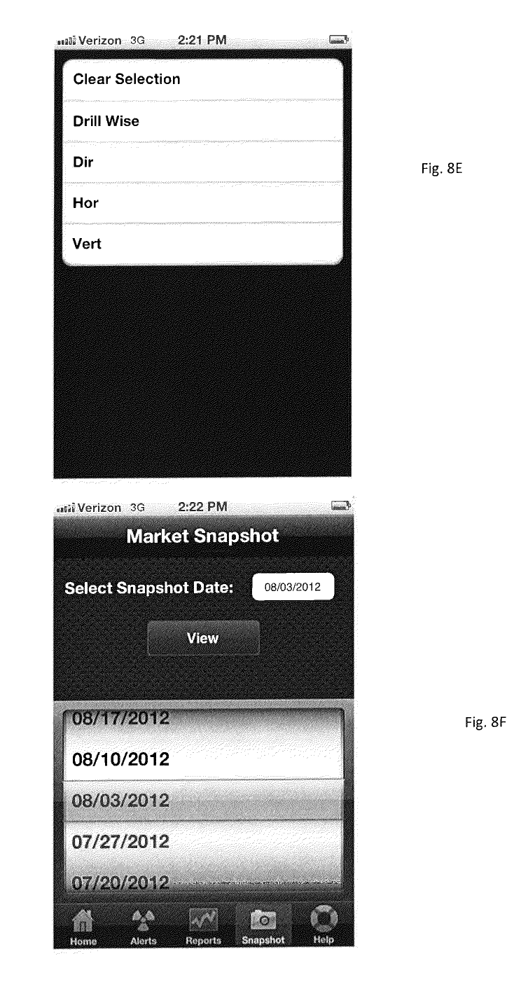

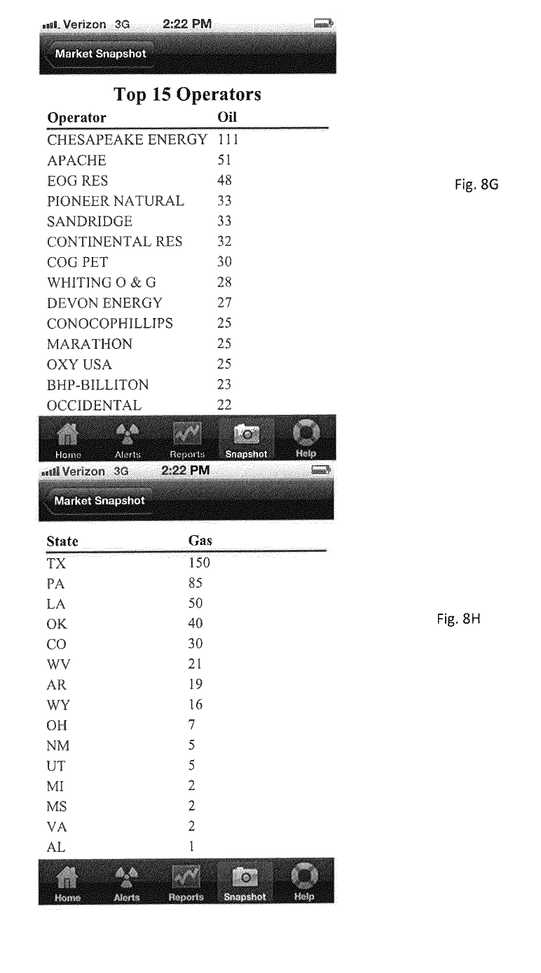

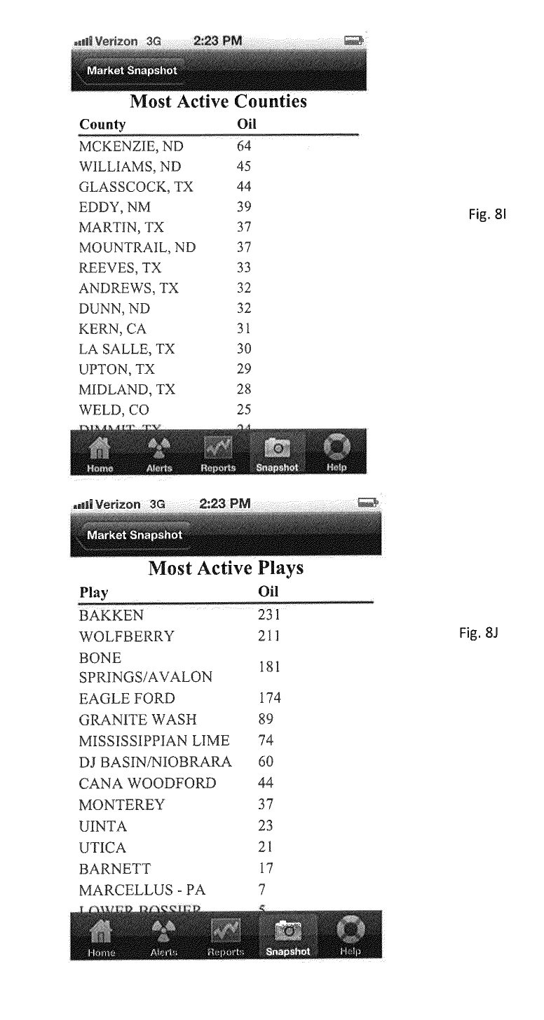

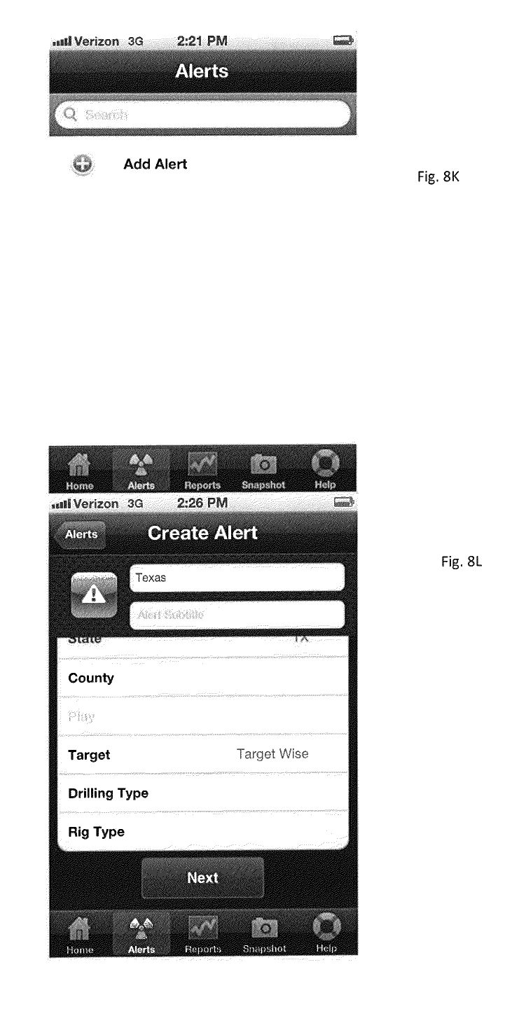

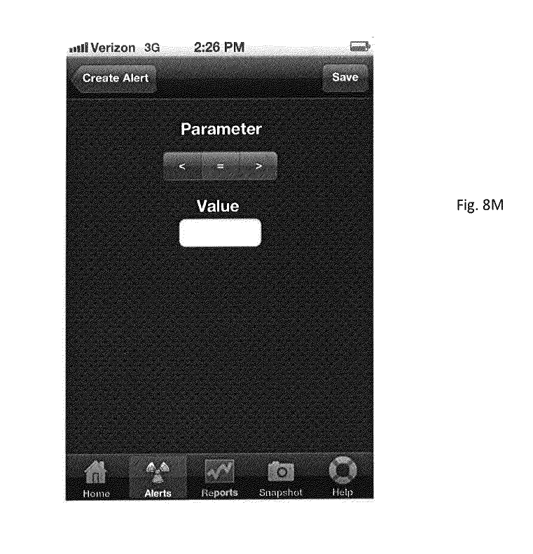

FIGS. 8A-8M illustrate a guided series of steps to creating a report and alert via screenshots on a remote device comprising a smartphone. FIG. 8A illustrates a home screen noting 0 alerts pending and offering buttons such as “Home” “Alerts” “Reports” “Snapshot,” and “Help” to jump to different portions of the application. FIG. 8B illustrates a “Reports” section of the application offering the user to view previously created reports or create a new report. FIG. 8C-8H illustrate a guide of questions to which the user can provide answers such that a query for a report may be generated. FIG. 8C illustrates that the user may input a report title, report subtitle, start date, end date, and other parameters such as state, county, play, target, drilling type, rig type, and other parameters discussed in this disclosure. FIG. 8D illustrates that the user may input one or more states. FIG. 8E illustrates that the user may input one or more drilling directions. FIG. 8F illustrates that the user may input one or more dates, time periods, start dates, end dates, and the like. Similarly, the user may input other parameters desired for the report. FIGS. 8G-8J illustrate how the report may appear to the user in at least one embodiment. FIG. 8G illustrates the top oil operators by name. FIG. 8H illustrates the top states producing gas by rig count. FIG. 8I illustrates the most active counties for oil production. FIG. 8J illustrates the most active plays for oil production. Similarly, other parameters of the report may be displayed. FIGS. 8K-8M illustrate a guided series of steps to creating an alert. FIG. 8K illustrates that there are no alerts previously created, and a button for creating an alert. FIG. 8L illustrates that a user may input a title, subtitle, state, county, play, target, drilling type, rig type, and other parameters discussed in this disclosure. FIG. 8M illustrates that the user may input a threshold value for each parameter such that the user is alerted when the parameter meets, exceeds, or goes lower than the threshold value. If multiple parameters are selected, the user may customize the combination to alert the user if any one or particular combination of parameters pass their respective thresholds.

The above disclosure is meant to be illustrative of the principles and various embodiment of the present invention. Numerous variations and modifications will are possible. It is intended that the following claims be interpreted to embrace all variations and modifications.

What is claimed is:

1. A non-transitory computer-readable storage medium comprising executable instructions that, when executed, cause one or more processors to:
receive, from a remote device, a query comprising parameters for energy production data;
search a database of energy production data, comprising oil production data or natural gas production data, for energy production data falling within the parameters of the query (“resultant data”);
send, to the remote device in response to the query, the resultant data in a form specified by the parameters of the query.

2. The medium of claim 1, wherein the parameters comprise a parameter selected from the group consisting of region, target, drilling direction, rig type, operator, and service provider.

3. The medium of claim 2, wherein the region parameter comprises a parameter selected from the group consisting of country, state, county, and play.

4. The medium of claim 2, wherein the drilling direction parameter comprises a parameter selected from the group consisting of horizontal, vertical, directional, and specific angle of drilling.

5. The medium of claim 2, wherein the rig type parameter comprises a parameter selected from the group consisting of platform, drill ship, semi-submersible, jackup rig, land rig, and float rig.

6. The medium of claim 2, wherein the operator and service provider parameters comprise names of energy production firms.

7. The medium of claim 1, wherein the form comprises a graph and wherein the parameters comprise units in which the graph should be displayed.

8. The medium of claim 1, wherein the form comprises raw data to be constructed into graphs by the remote device.

9. The medium of claim 1, wherein the one or more processors are further caused to receive a second query, the second query automatically generated by the remote device based on selection of a parameter from the resultant data.

10. The medium of claim 1, wherein the parameters comprise a threshold and wherein the resultant data is sent whenever the energy production data meets or exceeds the threshold.

11. The medium of claim 1, wherein the resultant data comprises a report comprising a selection of ranked data according to a threshold.

12. The medium of claim 1, wherein the resultant data comprises a spreadsheet of energy production data.

13. The medium of claim 1, wherein the query is generated from inputs to a graphical user interface on the remote device.

14. A system, comprising:
A system comprising:
one or more processors;
memory coupled to the one or more processors;
the memory comprising executable instructions that, when executed, cause the one or more processors to:
receive, from a remote device, a query comprising parameters for energy production data;
search a database of energy production data, comprising oil production data or natural gas production data, for energy production data falling within the parameters of the query (“resultant data”);
send, to the remote device in response to the query, the resultant data in a form specified by the parameters of the query.

15. The system of claim 14, wherein the one or more processors are further caused to receive a second query, the second query automatically generated by the remote device based on selection of a parameter from the resultant data.

16. The system of claim 14, wherein the parameters comprise a threshold and wherein the resultant data is sent whenever the energy production data meets or exceeds the threshold.

17. A method, comprising:
receiving, using one or more processors, from a remote device, a query comprising parameters for energy production data;
searching, using the one or more processors, a database of energy production data, comprising oil production data or natural gas production data, for energy production data falling within the parameters of the query (“resultant data”); and
sending, using the one or more processors, to the remote device in response to the query, the resultant data in a form specified by the parameters of the query.

18. The method of claim 17, further comprising receiving a second query, the second query automatically generated by the remote device based on selection of a parameter from the resultant data.

19. The method of claim 17, wherein the parameters comprise a threshold, and wherein sending the resultant data comprises sending the resultant data whenever the energy production data meets or exceeds the threshold.

20. The method of claim 17, wherein the parameters comprise a parameter selected from the group consisting of region, target, drilling direction, rig type, operator, and service provider.
